(19) United States
(12) Patent Application Publication
(10) Pub. No.: US 2010/0164687 A1
(43) Pub. Date: Jul. 1, 2010

(54) RFID READER AND IDENTIFICATION METHOD FOR IDENTIFYING THE SAME

(75) Inventors: Shin-Yao Perng, Hsinchu (TW); Ta-Yung Lee, Hsinchu (TW); Yuan-Ning Hsieh, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/345,938

(22) Filed: Dec. 30, 2008

(51) Int. Cl. H04Q 5/22

(52) U.S. Cl. 340/10.1

(57) ABSTRACT

A method for identifying an RFID (Radio Frequency IDentification) reader is provided. A first transmission path is defined between a first RFID reader and a host apparatus in a RFID system. A second transmission path is defined between the host apparatus and a second RFID reader adjacent to the first RFID reader. When the host apparatus is identifying the first RFID reader, the first RFID reader sends first identification data of the first RFID reader through the first transmission path to the host apparatus. The first RFID reader also sends first-resent identification data of the first RFID reader through the second transmission path to the host apparatus. The host apparatus identifies the first RFID reader by comparing the first identification data and the first-resent identification data transmitted through the first transmission path and the second transmission path respectively, thereby double confirming the identification data of the first RFID reader.

### BACKGROUND OF THE INVENTION

1. Field of the Invention

The present invention relates to an identifying technology through RFID (Radio Frequency IDentification) system, and more particularly to a RFID reader and an identification method for identifying the RFID reader thereof.

2. Related Art

The conventional composition of an RFID system mainly includes a RFID tag, at least one RFID reader and at least one backend computer host. The RFID tag is a component of data storage, while RFID reader reads the data stored in the RFID tag or writes data into the RFID tag. After receiving the wireless signals of the RFID tag, the read data may be sent to the backend computer host for further processing.

RFID tag has two major types: active-type and passive-type. The active-type RFID tag has battery integrated therein. With the integrated battery implemented in the RFID tag, the active RFID tag may instantly sends data to the RFID reader, and meanwhile has a longer communication distance and a memory with a larger storage space; but more expensive. The passive RFID tag has only the power of micro-current generated from the passive RFID tag sensing the radio frequency transmitted from the RFID reader; on the other hand, the radio frequency and its energy are also used to send the data stored in the passive RFID tag back to the RFID reader. Even with a shorter communication distance, the passive RFID still tag has advantages including no battery required, smaller volume, cheaper, longer product life and easy-to-carry. Generally the antenna of the passive RFID tag is configured inside the passive RFID tag to sense the radio frequency and generate the micro sensing current, thereby receiving and transmitting data between the RFID reader and the passive RFID tag.

RFID tag may be used in various applications, including local controlling system, entrance guarding system, goods transportation system, operation security system and operation material management system and etc. One prior art wears an active RFID tag on a student. When the student passes a control area or a forbidden zone with RFID reader(s) configured therein, the active RFID tag on the student will receive a driving signal from the RFID reader and then send the data stored in the active RFID tag to the RFID reader. The RFID reader in the control area or the forbidden zone will send the received data (from the active RFID tag) to a management server with management software. The management software will then integrate the received data and may send to an application server for further processing and sending to the right person to take actions. The application server may transmit the integrated data to the parents or school/teacher of the student. Mobile phone or computer may be also used to receive presence information of the student, including the presence information that the student arrives school on time, leaves school without authorization, breaks in a forbidden zone or stays in the school bus overtime; thereby allowing the parents/teachers instantly to receive the information of the student.

However, to an end user, there is only the information of the RFID tag may be sensed or retrieved by the RFID reader. The information of the RFID reader itself is not easy to be acquired. When trying to identify a RFID reader in the prior, the user may only count on the data sent back from the RFID reader to identify which RFID reader sent the data. Once the data is retrieved and changed without authorization, a fake RFID reader may be used to transmit fake information/data and the user will not be able to differentiate the real RFID reader or the fake one. Therefore, the identification RFID reader in the prior art is too simple so that the information security can be easily disabled and become very risky.

Furthermore, upon disposing the RFID readers in a target area, since the RFID reader itself in the prior art is not able to feedback the location where the RFID reader locates. The engineer will need to record the locations/positions of the RFID readers by himself. Once the RFID reader is moved by external factors after completing the arrangement, the engineer's recorded data regarding the original disposing location will lead to wrong results. Such problem will not be easily avoided unless the engineer himself checks at the actual location of the RFID reader, and also modifies the location of the RFID reader into the current one. However, such method is troublesome and lack of efficiency.

### SUMMARY OF THE INVENTION

To resolve the technical problems in the prior art, the present invention provides a method for identifying a RFID (Radio Frequency IDentification) reader. In the method, a first transmission path is defined between a first RFID reader and a host apparatus in a RFID system. A second transmission path is defined between the host apparatus and a second RFID reader adjacent to the first RFID reader. When the host apparatus is identifying the first RFID reader, the method conducts the first RFID reader to send “first identification data” of the first RFID reader through the first transmission path to the host apparatus. On the other hand, the first RFID reader also sends “first-resent identification data” of the first RFID reader through the second transmission path to the host apparatus. The host apparatus identifies the first RFID reader by comparing the first identification data and the first-resent identification data transmitted through the first transmission path and the second transmission path respectively, thereby double confirming the identification data of the first RFID reader.

In an embodiment of the present invention, the first RFID reader and the second RFID reader each has a microprocessor in circuit connection with a memory unit, an identification storage unit storing the identification data, a RFID transceiver and a transmission unit.

In another embodiment of the present invention, the identification storage unit is part of a RFID tag integrated on the RFID reader. The RFID tag connects with the microprocessor through a tag connection interface. The identification data of the RFID reader is stored within the identification storage unit of the RFID tag. When the first RFID reader transmits the identification data to the second RFID reader, the identification data is transmitted from the second RF transceiver of the RFID tag within the first RFID reader.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a system block diagram of a RFID system according to the RFID reader identification method of the present invention;

FIG. 2 is a control flow chart of the RFID reader identification method of the present invention;

FIG. 3 is a system block diagram of a RFID system according to the first embodiment of the present invention;

FIG. 4 is a circuit block diagram of the first embodiment in the present invention;

FIG. 5 is a control flow chart according to the first embodiment of the present invention;

FIG. 6 is a circuit block diagram with a reverse transmission direction of the first embodiment in the present invention;

FIG. 7 is a system architecture of a RFID system according to a second embodiment of the present invention;

FIG. 8 shows a circuit block diagram of a RFID reader according to the second embodiment of the present invention; and

FIG. 9 shows a control flow chart according to the second embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

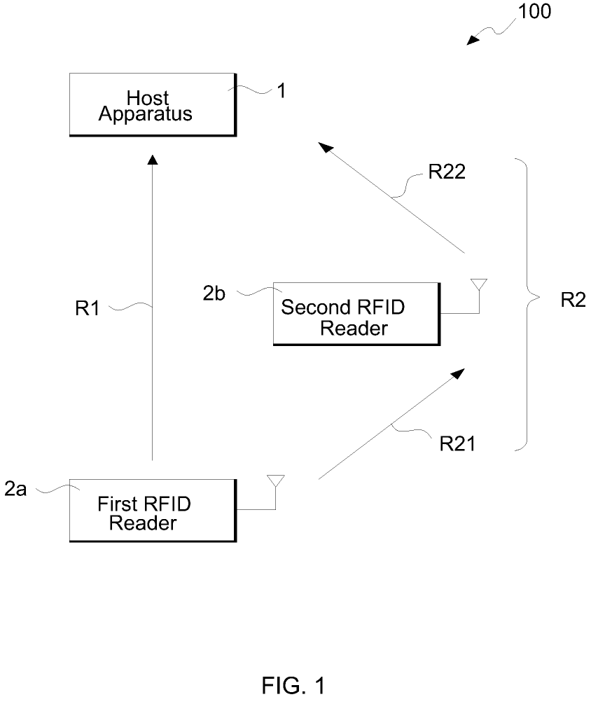

Referring to FIG. 1, which shows a system block diagram of a RFID (Radio Frequency IDentification) system 100 according to the RFID reader identification method of the present invention. The RFID system 100 includes a host apparatus 1, a first RFID reader 2a and a second RFID reader 2b; wherein, a first transmission path R1 is defined between the first RFID reader 2a and the host apparatus 1. Through the second RFID reader 2b adjacent to the first RFID reader 2a, a second transmission path R2 (R21+R22) is also defined between the host apparatus 1 and the second RFID reader 2b.

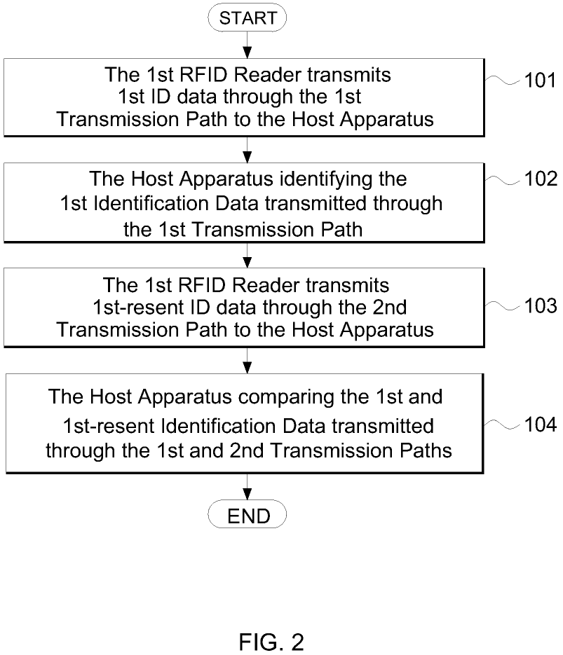

Referring to FIG. 2 in parallel, which shows a control flow chart of the RFID reader identification method according to the present invention. First of all, when identifying the first RFID reader 2a, the method conducts the first RFID reader 2a to transmit a first identification (ID) data through the first transmission path R1 to the host apparatus 1 (step 101). Afterwards, the host apparatus 1 identifying the first identification data transmitted through the transmission path R1 (step 102). On the other hand, the first RFID reader 2a itself will transmit its identification data to random directions, first-resent identification data will be received by the second RFID reader 2b through the RF transmission path R21. The first and first-resent identification data are both the same identification data of the first RFID reader, only the first and first-resent identification data may be transmitted at different timings, through different carriers (such wireless signals, network packet and etc.) and through the different first and second transmission paths. After the second RFID reader 2b receives the first-resent identification data, the first-resent identification data will be transmitted to the host apparatus 1 through a data packet transmission path R22 (step 103); wherein, RF transmission path R21 and the data packet transmission path R22 forms the second transmission path R2 mentioned above. Next, the host apparatus 1 compares the first identification data transmitted through the first transmission path R1 and the first-resent identification data transmitted through the second transmission path R2 (step 104), thereby facilitating double confirmation of identification of the first RFID reader 2a.

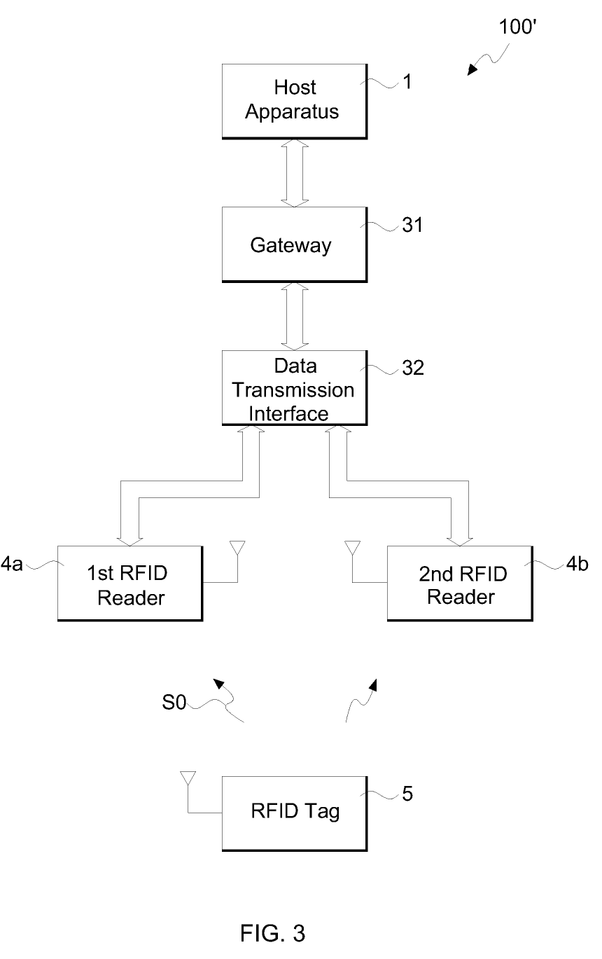

Referring to FIG. 3, which shows a system block diagram of a RFID system according to the first embodiment of the present invention. The RFID system 100′ includes a host apparatus 1. The host apparatus 1 connects with a first RFID reader 4a and a second RFID reader 4b through a gateway 31 and a data transmission interface 32. In the present embodiment, data transmission interface 32 is an Ethernet network interface or a Power Line Communication (PLC) interface or other interfaces available for data transmission; the first RFID reader 4a and the second RFID reader 4b generally retrieve tag information S0 sent from a RFID tag 5.

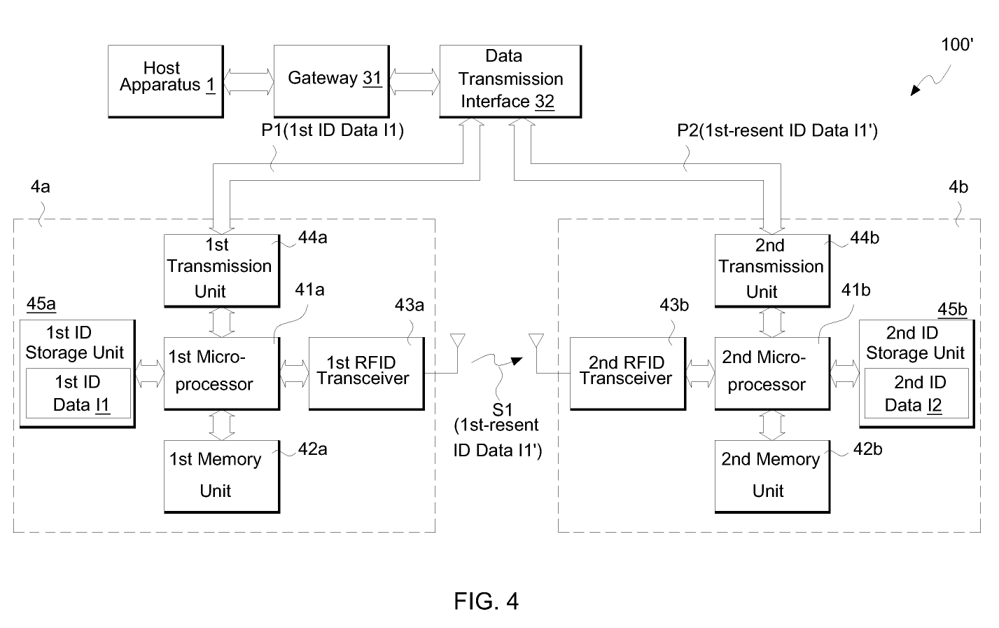

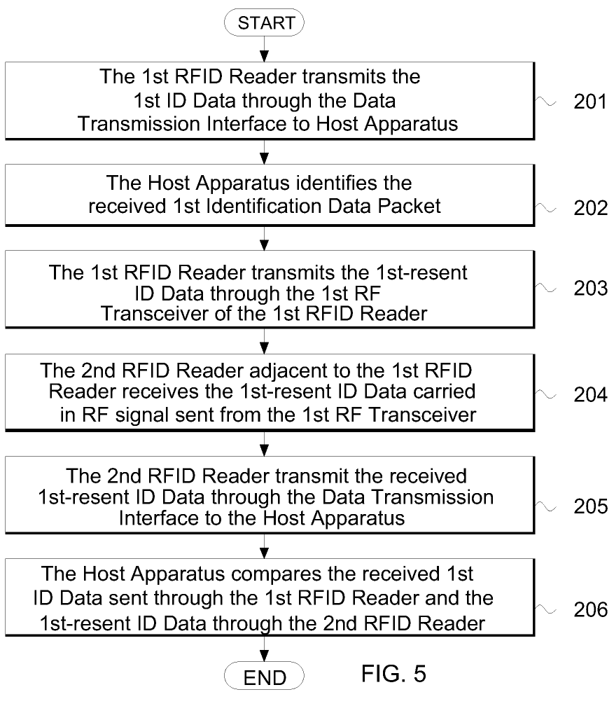

Referring to FIG. 4 and FIG. 5, which show a circuit block diagram and a control flow chart of the first embodiment in the present invention. The first RFID reader 4a includes a first microprocessor 41a, which connects with a first memory unit 42a, a first RF (radio frequency) transceiver 43a, a first transmission unit 44a and a first identification storage unit 45a. The second transmission unit 44a connects with the data transmission interface 32; the first identification storage unit 45a has first identification (ID) data I1 stored therein. Similarly, the second RFID reader 4b includes a second microprocessor 41b, which also connects with a second memory unit 42b, a second RF transceiver 43b, a second transmission unit 44b and a second identification storage unit 45b. The second transmission unit 44b connects with the data transmission interface 32; the second identification storage unit 45b has second identification data I2 stored therein.

When identifying the first RFID reader, the first microprocessor 41a of the first RFID reader 4a will transmit a first identification data packet P1 by the first transmission unit 44a to carry the first identification data I1 stored in the first identification storage unit 45a. The transmitted first identification data packet P1 will be transmitted through the data transmission interface 32, the gateway 31 to the host apparatus 1 (step 201). Next, the host apparatus 1 identifies the received the first identification data packet P1 (step 202); through the first identification data I1 carried within the identification data packet P1, the host apparatus 1 identifies the first RFID reader 4a.

Afterwards, through the RF transceiver 43a of the first RFID reader 4a, the first microprocessor 41a of the first RFID reader 4a transmits a RF (radio frequency) signal S1 carrying a first-resent identification data I1′ (step 203). Since through such RF transmission, the communication protocols of the RF signal S1 will be the same protocol as the RFID tag 5 transmitting the tag information S0, plus the first-resent identification data I1′ may be an tag identification code, the second RFID reader 4b adjacent to the first RFID reader 4a will take the first RFID reader 4a as a RFID tag. Therefore, as the same as receiving the tag information S0 sent from the RFID tag 5, the second RFID reader 4b will receive the RF signal S1 and thereby obtaining the first-resent identification data I1′ (step 204). Certainly, the first identification data I1 and the first-resent identification data I1′ are substantially the same identification data representing the first RFID reader 4a, only the carrier, timing and transmission path are different.

When the second RFID reader 4b received the first-resent identification data I1′, a first-resent identification data packet P2 carrying the first-resent identification data I1′ will be transmitted by the second transmission unit 44b of the second RFID reader 4b. The first-resent identification data packet P2 will be transmitted through the data transmission interface 32, the gateway 31 (gateway is only for multiple entries and is not essential to the present invention) to the host apparatus 1 (step 205). After the host apparatus 1 receives the firs-resent identification data packet P2, the first identification data I1 and the first-resent identification data I1′ will be compared by the host apparatus 1 (step 206). If the first and first-resent identification data packets P1, P2 are faked or changed during the transmission, the comparison results will show the findings of fake, thereby double checking the conditions of the first RFID reader 4a.

Within the present embodiment, only the single second RFID reader 4b is taken as an example, but it is not limited to the amount RFID reader within the RFID system of the present invention. In a preferred embodiment, multiple RFID readers may be implemented in the same RFID system; and each of them can help to identify the first RFID reader 4a. Namely the double confirmation of the embodiment above will be adapted to a multiple confirmation. Meanwhile, such multiple confirmations will help to confirm the positions of the identified RFID reader; for example, whether the position of the first RFID reader 4a is changed from being adjacent to the second RFID reader 4b to the neighborhood of other RFID readers, thereby determining the current position of the first RFID reader 4a.

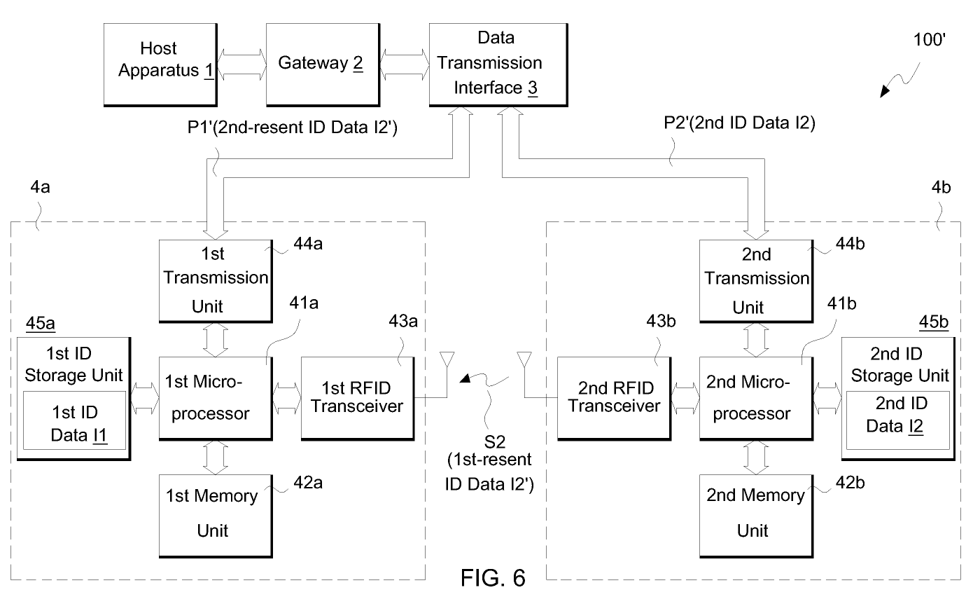

Referring to FIG. 6, which shows the circuit block diagram with a reverse transmission direction of the first embodiment in the present invention. Since the hardware and circuit structure of the second RFID reader 4b is similar to the first RFID reader 4a, the present invention may identify not only the first RFID reader 4a but also the second RFID reader 4b. The identification operations are similar to the operations of identifying the first RFID reader 4a as mentioned above; the difference is the identified object has been changed to the second RFID reader 4b.

Similarly, the second RFID reader 4b may also transmit a second identification data packet P2′ carrying its second identification data I2 to the host apparatus 1 for identification. Next, the second RFID reader 4b may transmits the second identification data I2 stored in the second identification storage unit 45b again. Through the RF transceiver 43b of the second RFID reader 4b, a RF signal S2 carrying second-resent identification data I2′ may be transmitted. Afterwards, when the first RFID reader 4a adjacent to the second RFID reader 4b receives the RF signal S2, the first RFID reader 4a will transmit a second identification data packet P1′ carrying the second-resent identification data I2′ through the data transmission interface 32, the gateway 31 to the host apparatus 1 for identification.

The foregoing embodiment uses the first RFID reader 4a and the second RFID reader 4b as an example to explain the identification method of the present invention may be applied to bidirectional identification. However, for those skilled in the art, based on the embodiment above will understand the amount of RFID readers should not be a limitation to the present invention, and meanwhile multiple cross-identification between multiple RFID readers may also be practical under the inventive steps of the present invention, and thereby facilitating a broad identification of RFID readers configured within an assigned area.

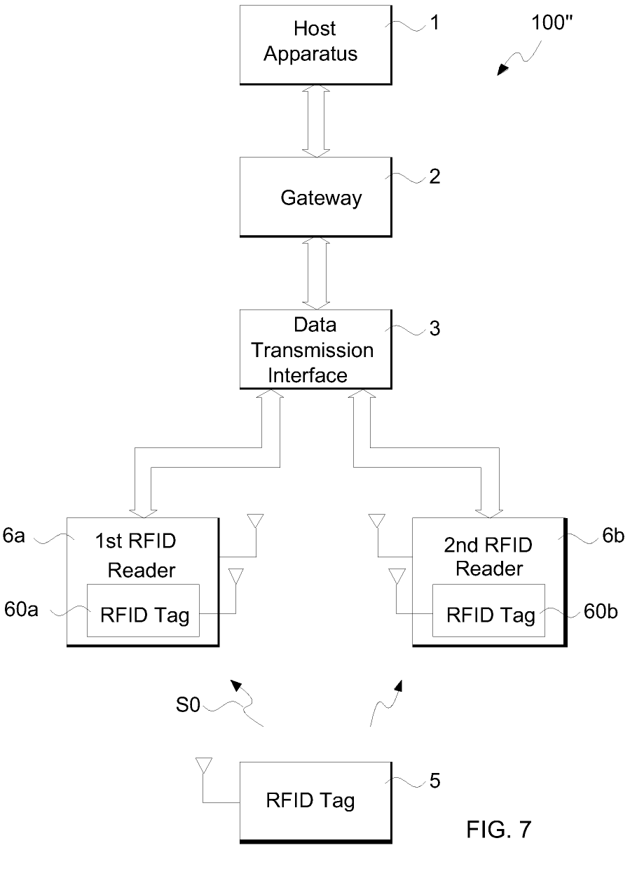

Referring to FIG. 7, which shows a system architecture of a RFID system according to a second embodiment of the present invention. This embodiment discloses a RFID system 100″ similar to the first embodiment. The difference is only to replace the first RFID reader 4a and the second RFID reader 4b by the first RFID reader 6a and the second RFID reader 6b.

The difference between the first RFID reader 6a and the aforesaid first RFID reader 4a is that the first RFID reader 6a includes a RFID tag 60a. Similar to the first RFID reader 6a, the second RFID reader 6b also has a RFID tag 60b equipped therein. The RFID tags 60a, 60b may be active-type or passive type. For a passive RFID tag equipped on the RFID reader, there may not be a microprocessor equipped on the passive RFID tag but a sensing antenna of the passive RFID tag may be used as a radio frequency transceiver.

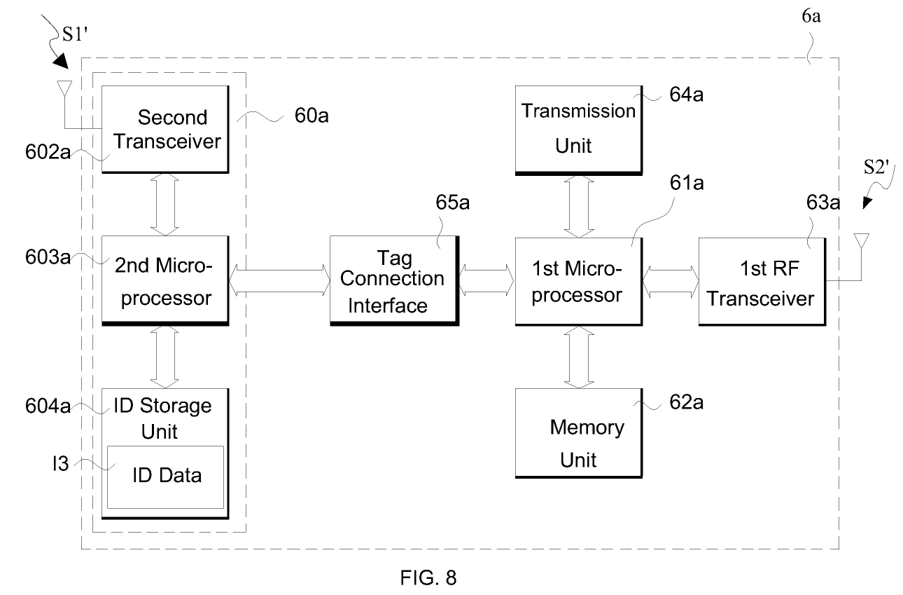

Referring to FIG. 8, which shows a circuit block diagram of a RFID reader according to the second embodiment of the present invention. The first RFID reader 6a comprises a first microprocessor 61a connecting with a memory unit 62a, a first RF transceiver 63a and a transmission unit 64a. The first microprocessor 61a connects with the RFID tag 60a through a tag connection interface 65a. The RFID tag 60a includes a second microprocessor 601a, a second RF transceiver 602a connecting with the second microprocessor 601a and an identification storage unit 603a having identification data I3 stored therein.

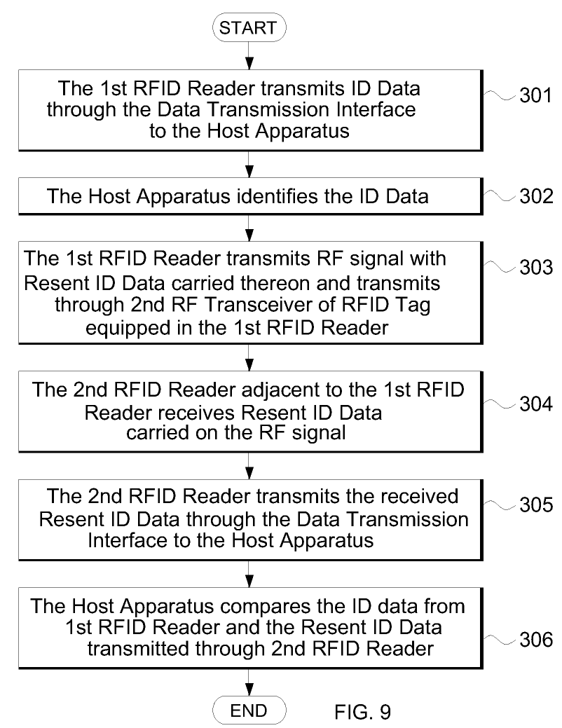

Referring to FIG. 9, which shows a control flow chart according to the second embodiment of the present invention. The control procedures of the present embodiment are similar to the first embodiment. The first microprocessor 61a of the first RFID reader 6a transmits the identification data I3 stored in the identification storage unit 603a to the host apparatus 1 through the data transmission interface 32 (step 301). Then, the host apparatus 1 identifies the identification data (step 302). Next, the first microprocessor 61a of the first RFID reader 6a transmits a RF signal S1′ carrying a resent identification data I3′ through the second RF transceiver 602a of the RFID tag 60a (step 303). Certainly, the identification data I3 and the resent identification data I3′ are substantially the same identification data representing the RFID reader 6a, only the carrier, timing and transmission path are different. Afterwards, the second RFID reader 6b adjacent to the first RFID reader 6a receives the resent identification data I3′ carried on the RF signal S1′ (step 304), and then transmits the resent identification data I3′ to the host apparatus 1 (step 305). After the host apparatus 1 receives the recent identification data I3′, the host apparatus 1 compares the resent identification data I3′ and the identification data I3 of the first RFID reader 6a transmitted through the data transmission interface 32 (step 306). Similar to the first embodiment of the present invention, the second embodiment of the present invention may identify the second RFID reader 6b by the first RFID reader; only simply reverse the transmission direction. In such implementation, the second RFID reader 6b will transmit a RF signal S2′ and the first RF transceiver 63a of the first RFID reader 6a will receive the RF signal S2′.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. An identification method for identifying a first RFID (Radio Frequency IDentification) reader of a RFID system, the RFID system also having a host apparatus and at least one second RFID reader adjacent to the first RFID reader, a first transmission path being defined between the first RFID reader and the host apparatus and a second transmission path being defined between the second RFID reader and the host apparatus, the identification method comprising the steps of:
(a) the first RFID reader transmitting first identification data of the first RFID reader through the first transmission path to the host apparatus;
(b) the host apparatus identifying the first identification data transmitted through the first transmission path;
(c) the first RFID reader transmitting first-resent identification data of the first RFID reader through the second transmission path to the host apparatus; and
(d) the host apparatus comparing the identification data transmitted through the first transmission path and the first-resent identification data transmitted through the second transmission path to identify the first RFID reader.

2. The identification method as claimed in claim 1, wherein the first transmission path comprises the first RFID reader transmitting through a data transmission interface to the host apparatus.

3. The identification method as claimed in claim 2, wherein the data transmission interface comprises an Ethernet network interface or a Power Line Communication (PLC) interface.

4. The identification method as claimed in claim 2, wherein the RFID system further comprises a gateway configured between the host apparatus and the data transmission interface.

5. The identification method as claimed in claim 1, wherein the second transmission path comprises the first RFID reader transmitting through the second RFID reader, a data transmission interface to the host apparatus.

6. The identification method as claimed in claim 5, wherein the data transmission interface comprises an Ethernet network interface or a Power Line Communication (PLC) interface.

7. The identification method as claimed in claim 6, wherein the RFID system further comprises a gateway configured between the host apparatus and the data transmission interface.

8. The identification method as claimed in claim 1, wherein in the step (a), the first RFID reader transmits the first identification data through a transmission unit of the first RFID reader.

9. The identification method as claimed in claim 1, wherein in the step (c), the first RFID reader transmits the first-resent identification data through a first RF (Radio Frequency) transceiver of the first RFID reader.

10. The identification method as claimed in claim 9, wherein the firs-resent identification data transmitted from the first RFID readers is received by a second RF transceiver of the second RFID reader.

11. The identification method as claimed in claim 1, wherein in the step (c), the first RFID reader transmits the first-resent identification data through a RF transceiver of a RFID tag equipped on the first RFID reader.

12. The identification method as claimed in claim 11, wherein the first-resent identification data transmitted from the first RFID reader is received by a second RF transceiver of the second RFID reader.

13. The identification method as claimed in claim 1, wherein the identification data comprises a tag identification code.

14. A RFID (Radio Frequency IDentification) reader, comprising:
a microprocessor;
a memory unit connecting with the microprocessor;
an identification storage unit connecting with the microprocessor, the identification storage unit having an identification data stored therein;
a RF transceiver connecting with the microprocessor, under control of the microprocessor the RF transceiver receiving and transmitting tag information of a target RFID tag, the RF transceiver receiving identification data of an adjacent RFID reader; and
a transmission unit connecting with the microprocessor, through the transmission unit the RFID reader transmitting the identification data of the adjacent RFID reader to a host apparatus.

15. The RFID reader as claimed in claim 1, wherein the identification data is a tag identification code.

16. A RFID (Radio Frequency IDentification) reader, comprising:
a first microprocessor;
a memory unit connecting with the first microprocessor;
a transmission unit connecting with the first microprocessor and allowing the RFID reader to transmit identification data through the transmission unit to the host apparatus;
a tag connection interface connecting with first microprocessor;
a RFID tag connecting with the first microprocessor through tag connection interface, the RFID tag comprising an identification storage unit storing the identification data of the RFID tag, and a second RF transceiver transmitting the identification data of the RFID tag; and
a first RF transceiver connecting with the first microprocessor, receiving and transmitting tag information of a target RFID tag and the identification data of an adjacent RFID reader.

17. The RFID reader as claimed in claim 16, wherein the identification data comprises a tag identification code.

18. The RFID reader as claimed in claim 16, wherein the RFID tag is a passive RFID tag and the second RF transceiver is a sensing antenna.

19. The RFID reader as claimed in claim 16, wherein the RFID tag is an active-type RFID tag.

20. The RFID reader as claimed in claim 16, wherein the RFID tag further comprises a second microprocessor connecting with the identification storage unit and the second RF transceiver.
